(19) United States
(12) Patent Application Publication
(10) Pub. No.: US 2008/0008357 A1
(43) Pub. Date: Jan. 10, 2008

(54) System And Method To Control The Variation Of An Animal's Mass

(76) Inventor: Fernando Menna Barreto Martins, Porto Alegre/RS (BR)

Correspondence Address: WELSH & KATZ, LTD, 120 S RIVERSIDE PLAZA, 22ND FLOOR, CHICAGO, IL, 60606, US

(21) Appl. No.: 11/774,050

(22) Filed: Jul. 6, 2007

Related U.S. Application Data
(60) Provisional application No. 60/819,324, filed on Jul. 7, 2006.

(51) Int. Cl. G06K 9/00

(52) U.S. Cl. 382/110; 340/572.1

(57) ABSTRACT

A system and method to control the variation of an animal's mass, such as for example a horse. The system comprises a data collection and identification terminal having a scale, at least one temperature sensing device and a camera; a microcomputer electronically connected to the terminal; and a radio-frequency identification system. According to the method, an animal is introduced to the terminal where it is identified via the radio-frequency identification system and weighed. A visual image of the animal is taken and the temperature of the animal is measured. The visual image and data concerning the weight and temperature are transmitted to the microcomputer. The data and visual image can additionally be visually displayed and printed at the terminal. The data and image are further transmitted to an electronic database where they can be remotely accessed and evaluated in order to control the training regimen of the animal.

### CROSS REFERENCE TO RELATED APPLICATION

This application claims priority from U.S. Provisional Patent Application Ser. No. 60/819,324 filed Jul. 7, 2006 entitled “System To Control The Mass Variation Of Animals,” the entirety of which is incorporated by reference as if fully set forth herein.

### FIELD OF THE INVENTION

The present invention is directed to a system and method for controlling the variation of an animal's mass, and is particularly directed to an improved system and method for monitoring and accessing information concerning the mass of an animal over time such that the animal's mass can be controlled or manipulated in response to various health or environmental conditions.

### BACKGROUND OF THE INVENTION

Horses, like most other animals, can be more susceptible to a variety of health and performance problems when they become overweight or obese. Overweight horses for instance can become easily fatigued, require increased respiratory efforts and are generally more susceptible to increased leg trauma or developing orthopedic disease. Conversely, a horse that is extremely underweight may be experiencing other types of health problems such as infection or internal hemorrhaging. Monitoring and managing a horse's weight is thus extremely important in maintaining a productive and healthy animal. An essential part of managing a horse's weight requires measuring or weighing the horse on a regular basis. Regularly determining the weight or mass of a horse can provide verification to trainers or owners as to the health of the animal and that a particular diet or training regimen is working. Alternatively, trainers or owners can modify the horse's diet or training regimen if an unhealthy weight is detected.

Despite technological advances in the field of veterinary and equine sciences, a horse's weight is still often times regularly gauged by sight. While visual inspection is an important part of weight management, errors can result from estimating. In fact, according to recent research, even experienced equine veterinarians and horse owners have been known to under-guess the weight of an adult horse by up to a hundred pounds, which can sometimes be a difference of about ten percent.

A slightly more accurate method to determine the weight of a horse involves using a weight tape. In this method, the horse's weight is determined by wrapping the tape around the heart girth of the horse directly behind the elbow, overlapping the ends of the tape and reading the resulting measurement. The measurement is then evaluated against the length of the horse using a standard table in order to determine an estimate of the overall weight. However, since there is no such thing as an average horse, this method involves a certain amount of guesswork and is thus not extremely accurate. For instance, since the girth measurement is compared against an average horse length, a horse that is long-backed may have more weight than indicated and alternatively the weight of a horse that is short-coupled may be overestimated. This method is also not as accurate with foals because they are still developing.

The use of a scale is the best and most accurate method of determining the weight or mass of a horse. While cost and convenience have limited this method in the past, recent advances in portable scales have made this option more affordable and user friendly. The use of a scale by itself however is generally only useful to determine the mass of a horse and thus provides only limited information concerning the health of the animal. The health or overall physical condition of a horse can also be better assessed via visual inspection and by measuring the temperature of the animal.

It would thus be useful to have a system and method that can accurately measure the mass and temperature of an animal, such as for example a horse, and to also simultaneously capture a visual image of the horse so as to enable persons to visually inspect the horse. It would be further useful if such a system and method could accurately measure the ambient temperature and air humidity at the location where information concerning the horse is being collected. It would be further useful if such a system and method could electronically transmit and store the visual information and weight and temperature data so that it could be readily accessed by animal trainers, owners and veterinarians such that these individuals could control the mass of the horse in response to health or environmental conditions. When used in connection with racing horses it would be additionally useful if certain information could be accessed by those persons placing wagers on particular horses. Finally, it would be additionally useful if the system or method could register and store the identity of the horse upon taking an initial weight measurement so that information concerning the horse could be readily retrieved and accessed for successive weight measurements or evaluations.

A system and method incorporating these features would provide horse trainers, owners and veterinarians a reliable and convenient means of measuring, monitoring, storing, retrieving and accessing the mass and temperature of a horse and would further enable such persons to monitor and control variations of the horse's mass. In controlling the variations of a horses mass, trainers, owners and veterinarians would be better able to ensure that the mass of the horse remains within or returns to acceptable parameters so that the horse is likelier to stay healthy and productive.

### SUMMARY OF THE INVENTION

One embodiment of the present invention is directed to a system to control the variation of an animal's mass, such as for example a horse. In this embodiment, the system features a data collection and identification terminal having a scale suitable for measuring the mass of an animal, at least one temperature sensing device and a camera suitable for capturing a visual image of the animal. The system further includes a microcomputer electronically connected to the terminal. The microcomputer features a microprocessor and operating system suitable for storing data collected from the terminal. A radio-frequency identification system is another feature of the system of this embodiment. The identification system has a reader electronically connected to the microcomputer and transponder suitable for being affixed to the animal. The reader features an operatively associated antenna suitable for transmitting and receiving radio frequency (RF) signals to the transponder and is suitable for transferring information received from the transponder to the microcomputer.

In this embodiment, the visual image of the animal can be displayed at the terminal and a printer can be utilized to generate bar codes, labels, tickets or documents identifying the animal or containing the data collected by the scale or temperature sensing device. The temperature sensing device of this embodiment can for example a thermometer or sensor and can be adapted to measure the ambient temperature at the terminal in addition to the animal's temperature. A hygrometer to measure the humidity of the air at the terminal can additionally be provided.

In one embodiment, the microcomputer can additionally feature and operatively associated modem electronically connected to an electronic database such as for example a server suitable for storing data files. In this embodiment, the database can be electronically connected to the modem via the internet or through an internal network via Ethernet. Individuals such as trainers, owners or veterinarians can access the database in order to obtain information concerning the animal. In addition, in circumstances where the animal is involved in racing or other sporting contests, individuals wagering on the contest may obtain access to the animal's data in order to make a more informed wager.

Another embodiment of the present invention is directed to a method for controlling the variation of an animal's mass. In this embodiment, a system according to the aforeferenced embodiment is provided. The animal is introduced to the terminal of the system and identified and/or registered using the radio-frequency identification system. The weight of the animal is then taken on the scale and the temperature of the animal is measured. A visual image of the animal is also captured by the camera and can be displayed at the terminal or at a remote location. The visual image and data concerning the weight and temperature of the animal is transmitted from the terminal to the microcomputer. The data or image can also be printed at the terminal by the printer. In this embodiment, the data and visual image from the microcomputer can then be transmitted to an electronic database such as for example a server. Users such as trainers, owners, veterinarians or gamblers can then access the database, read the data and depending on their relationship with the animal use the data to control the training regimen of the animal.

It is an object of the present invention to provide a reliable system and method of determining the mass of an animal, such as for example a horse and to be able to transmit data concerning the mass to a remote location where it can be readily accessed. It is a further object of the present invention to provide a system and method which enables other information including the temperature an visual appearance of the animal to be efficiently collected and transmitted to a remote location where it can be readily accessed. A further object of the present invention is to provide a system and method of efficiently registering and identifying an animal using radio-frequency identification. Another object of the invention is to provide a system and method which allows trainers, owners and veterinarians a means to access critical health information concerning an animal from a local or remote location so that corrective action can be taken should an unusual variation of mass be detected. Further objects, features and advantages of the present invention will be apparent from the following description and the appended claims when taken in conjunction with the accompanying drawings.

### BRIEF DESCRIPTION OF THE DRAWINGS

FIG. 1 is a schematic diagram of the control system according to one embodiment of the present invention.

FIG. 2 is a flow diagram illustrating the data collection process carried out in one embodiment of the present invention.

FIG. 3 is a flow diagram illustrating the registration process carried out in one embodiment of the present invention.

FIG. 4 is a flow diagram illustrating the consultation process carried out in one embodiment of the present invention.

### DETAILED DESCRIPTION

While the present invention is susceptible of embodiment in various forms, there is shown in the drawings a number of presently preferred embodiments that are discussed in greater detail hereafter. It should be understood that the present disclosure is to be considered as an exemplification of the present invention, and is not intended to limit the invention to the specific embodiments illustrated. It should be further understood that the title of this section of this application (“Detailed Description”) relates to a requirement of the United States Patent Office, and should not be found to limit the subject matter disclosed herein.

In this disclosure, the use of the disjunctive is intended to include the conjunctive. The use of the definite article or indefinite article is not intended to indicate cardinality. In particular, a reference to “the” object or “a” object is intended to denote also one of a possible plurality of such objects.

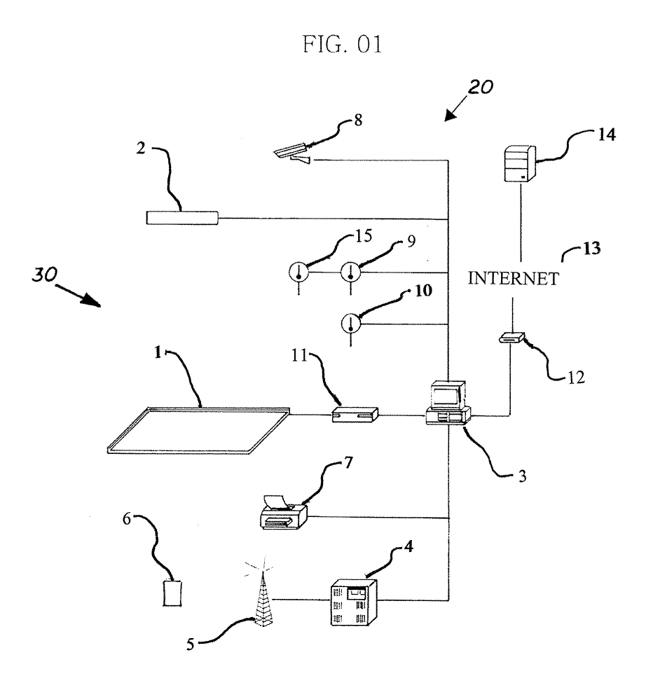

Referring now to the figures, and to specifically FIG. 1, a schematic diagram of a system 20 according to one embodiment of the present invention is shown. In this embodiment, the system 20 features a data collection and identification terminal 30 having a plurality of devices electronically connected to a microcomputer 3. As shown in FIG. 1, the terminal 30 can feature a scale 1, a camera 8 and display device 2 such as for example a video screen, a plurality of temperature sensing devices 9, 15, a hygrometer 10, a printer 7, and a radio-frequency identification system featuring a transponder 6 and transceiver/reader 4 including an operatively associated antenna 5. The system 20 can additionally include a modem 12 operatively associated with the microcomputer 3. As shown in FIG. 1, the modem 12 is connected to an electronic database 14, such as for example a file server through the internet (shown), or alternatively through an internal network via Ethernet (not shown).

In this embodiment, the terminal 30 features a scale 1 suitable for use in connection with animals such as for example horses. The scale 1 can be any kind of scale, including but not limited to an electronic scale. The scale 1 measures the weight of an animal and can transmit the weight as data to the microcomputer 3. An electronic terminal 11 can additionally be provided between the scale 1 and microcomputer 3 to assist in processing the data concerning the animal's weight. The camera 8 is further provided for capturing a visual image of the animal while the animal is on the scale 1. Those of ordinary skill in the art will understand that the camera 8 can be a conventional digital camera for taking still pictures or a video camera that is capable of recording video images. In this embodiment, the images of the animal captured by the camera 8 are transmitted to the microcomputer 3 and can additionally be transferred to a video display device 2 located at the terminal 30 or at a remote location. The video display device 2 can be for example a video screen, television or monitor or other suitable means for displaying video images. The video display device 2 can further be adapted to display measurements taken from the scale 1 and temperature sensing devices 9, 15. The video display device 2 of this embodiment is further adapted to display the visual image and data in real-time.

The terminal 30 additionally features at least one temperature sensing device 9, 15 suitable for measuring the temperature of the animal and the ambient temperature at the terminal 30. The temperature sensing device 9, 15 can be a thermometer, including but not limited to an infrared thermometer, temperature sensor or other means for measuring the air temperature or body temperature of an animal. A hygrometer 10 can additionally be provided for measuring the humidity of the air at the terminal. The temperatures and humidity measurements can be transmitted to the microcomputer 3 where they can be stored and displayed and further transmitted to a remote database 14.

The system 10 of this embodiment further includes a radio-frequency identification system featuring a transponder 6 and a receiver/reader 4 having an operatively associated antenna 5. The radio-frequency identification system is useful to register the animal upon its initial evaluation and to thereafter readily identify the animal upon repeated assessments. The transponder 6 is adapted to be implanted into the animal or otherwise affixed to the animal's body so that it can be detected by the antenna 5. The advantage of using radio-frequency identification is that identification of the animal can be done at greater distances and without requiring that the transponder 6 of the animal to be in a direct line of sight with the antenna 5.

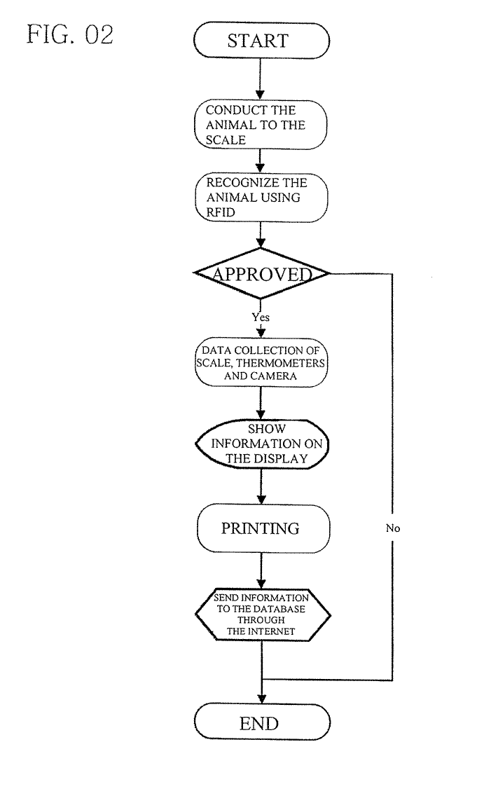

FIG. 2 is a flow diagram illustrating one embodiment of the method according to the present invention. In this embodiment, the method is for controlling the variation of an animal's mass. In this method, a system is provided comprising a data collection and identification terminal having a scale, at least one temperature sensing device and a camera; a microcomputer electronically connected to the terminal; and a radio-frequency identification system. As shown in the flow chart of FIG. 2, an animal is introduced or conducted to the terminal, and specifically the scale. The animal is identified using the radio-frequency identification system. When the system recognizes the animal as having been previously registered in the system, the weight and temperature of the animal is measured. A visual image of the animal is also taken or captured by the camera. As shown in FIG. 2, the visual image and data collected from the scale and temperature sensing device can be displayed in real-time at the terminal or at a remote location. In addition, such information and images can be printed at the terminal or at a remote location by a printer. As mentioned above, the printer can also print bar codes, labels or other documents containing the data.

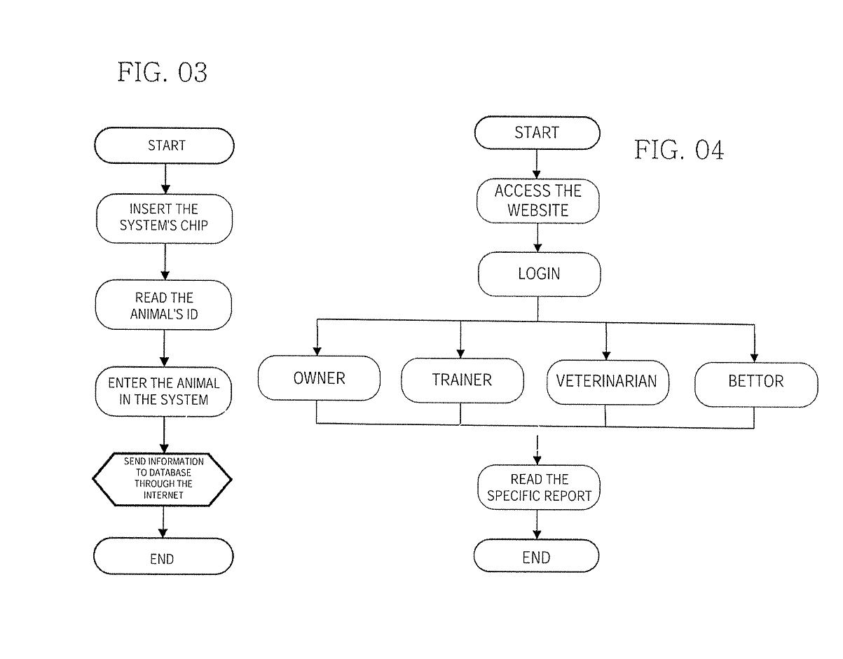

As shown in FIG. 2, the data, images and other information concerning the animal including for example the animal's identity are transmitted from their respective sources and collected by the microcomputer. The data and images are then transmitted to an electronic database such as for example a file server where they can be stored and accessed from remote locations. If, the animal being evaluated is not recognized by the system, the animal can be registered according to the method illustrated in FIG. 3. As shown in FIG. 3, the animal's identity is read and entered into the system and a radio-frequency transponder is assigned, formatted and affixed to the animal. Once the animal is registered in the system, the system will recognize the animal, the collected data and images can be transmitted to the database and can be associated with that animal's record.

FIG. 4 is a flow diagram that illustrates, according to one embodiment of the invention, a method in which a user can access and evaluate the stored data concerning the animal so that he or she can manipulate the training regimen of the animal in order to control the variation of the animal's mass. In this embodiment, the user through a computer terminal or electronic handheld device accesses and logs into a website or database where the stored data and images are located. The website or database will then verify the user's identity and depending on the user's position, provide access to particular data concerning the animal. An owner, trainer or veterinarian of a particular animal for instance may be granted access to all information concerning that animal, whereas certain data may be restricted from users who are logging into the website or database in order obtain information for purposes of placing a wager.

As shown in FIG. 4, the user then reads or evaluates the specific data to which they have access. A user who has control over the animal such as an owner or trainer may then control the animal's mass by manipulating the animal's training regimen in response to the collected data. For instance, in circumstances in which the data suggests that the animal is overweight, the owner or trainer can increase the exercise program and decrease the nutritional intake of the animal. Conversely, when the data suggests that the animal has unexpectedly lost an undesirable or unhealthy amount of weight, the owner or trainer can decide to have a veterinarian examine the animal or increase the nutritional intake of the animal. Finally, when the data suggests that the animal's mass is within acceptable parameters, the owner or trainer may continue the present training regimen in order to maintain the existing weight or mass.

In another embodiment of the invention, the microcomputer can be programmed to automatically evaluate the data and to further evaluate the data in comparison to previous measurements and average standards. When the data is outside the rage of the acceptable standards or when a unusually significant gain or loss is detected over previous measurements, the system can automatically transmit an electronic alert to a programmed user such as an owner or trainer to alert the user that an abnormal weight variation has been detected.

What is claimed is:

1. A system to control the variation of an animal's mass comprising:
a data collection and identification terminal, the terminal having a scale suitable for measuring the mass of an animal, at least one temperature sensing device, and a camera suitable for capturing a visual image of the animal;
a microcomputer electronically connected to the terminal, the microcomputer having a microprocessor and operating system suitable for storing data collected from the terminal; and
a radio-frequency identification system having a reader electronically connected to the microcomputer and transponder suitable for being affixed to the animal, the reader having an operatively associated antenna suitable for transmitting and receiving radio frequency (RF) signals to the transponder, the reader suitable for transferring information received from the transponder to the microcomputer.

2. The system of claim 1 wherein the terminal further comprises a means for displaying the visual image of the animal at the terminal.

3. The system of claim 1 wherein the terminal further comprises a printer connected to the microcomputer.

4. The system of claim 1 wherein the plurality of temperature sensing devices comprise at least one device for sensing a temperature of the animal and at least one device for sensing an ambient temperature at the terminal.

5. The system of claim 1 wherein the terminal further comprises a hygrometer suitable for sensing an air humidity at the terminal.

6. The system of claim 1 further comprising a modem operatively associated with the microcomputer and an electronic database suitable for storing data files, the database being electronically connected to the modem.

7. The system of claim 6 wherein the database is electronically connected to the modem via the internet.

8. The system of claim 6 wherein the database is electronically connected to the modem through an internal network via Ethernet.

9. A method for controlling the variation of an animal's mass comprising:
providing a system comprising a data collection and identification terminal having a scale, at least one temperature sensing device and a camera; a microcomputer electronically connected to the terminal; and a radio-frequency identification system;
introducing an animal to the terminal;
identifying the animal using the radio-frequency identification system;
weighing the animal on the scale;
measuring the temperature of the animal;
capturing a visual image of the animal; and
transmitting the visual image and data concerning the weight and temperature of the animal from the terminal to the microcomputer;
displaying the data and the visual image of the animal;
printing the data;
transmitting the data and visual image from the microcomputer to an electronic database;
accessing the electronic database;
reading the data; and
controlling the animal's mass by manipulating the training regimen of the animal in response to the data.

10. The method of claim 9 further comprising:
measuring the ambient temperature at the terminal;
transmitting data concerning the ambient temperature from the terminal to the microcomputer;
displaying the data concerning the ambient temperature at the terminal;
transmitting the data concerning the ambient temperature from the microcomputer to an electronic database;

11. The method of claim 9 wherein the step of accessing the electronic database comprises:
accessing an internet website;
logging in to the website; and
identifying an individual logging in a person from a group consisting of an owner, trainer, veterinarian and bettor.

12. The method of claim 9 further comprising the step of registering the animal within the system, said step comprising:
affixing a radio-frequency identification transponder to the animal;
evaluating the animal's identification information;
entering the animal's identification into the system; and
transmitting the animal's identification from the microcomputer to an electronic database.

13. The method of claim 9 further comprising:
programming the microcomputer to automatically evaluate the data;
evaluating the data in comparison to previous measurements;
transmitting an electronic alert in response to abnormal weight variation.
